(19) United States
(12) Patent Application Publication
(10) Pub. No.: US 2021/0381602 A1
(43) Pub. Date: Dec. 9, 2021

(54) SEAL ASSEMBLY AND MANUFACTURING METHOD THEREOF

(71) Applicant: Trelleborg Sealing Solutions Germany GmbH, Stuttgart (DE)

(72) Inventor: Robert Nichols, Sturbridge, MA (US)

(73) Assignee: Trelleborg Sealing Solutions Germany GmbH, Stuttgart (DE)

(21) Appl. No.: 17/339,202

(22) Filed: Jun. 4, 2021

Related U.S. Application Data
(60) Provisional application No. 63/035,238, filed on Jun. 5, 2020.

(51) Int. Cl. F16J 15/34; B29D 99/00; B29C 33/38

(52) U.S. Cl. CPC F16J 15/3452; B29K 2623/18; B29C 33/3842; B29D 99/0053

(57) ABSTRACT

A method of assembling a seal includes presetting a spring in a core material and performing a lost core molding process with the spring being preset in the core, which provides for more exact manufacture, leading to lighter weight, higher performance and ability to make complex designs.

### CROSS REFERENCE TO RELATED APPLICATION

This is a non-provisional application based upon U.S. provisional patent application Ser. No. 63/035,238, entitled “SEAL ASSEMBLY AND MANUFACTURING METHOD THEREOF”, filed Jun. 5, 2020, which is incorporated herein by reference.

### BACKGROUND OF THE INVENTION

### 1. Field of the Invention

The present invention relates to seals, and, more particularly, to a spring energized elastomeric seal.

### 2. Description of the Related Art

Conventional methods of forming a seal result in inexact manufacture, fairly heavyweight product, poor performance and difficulty in producing complex designs.

### SUMMARY OF THE INVENTION

The present invention provides a manufacturing process for a spring-energized elastomeric seal, such as a fabric/silicone airframe seal with the internal spring tube. The spring is retained or preset in a particular shape by using a Paraplast® mandrel before the exterior seal material is bonded onto or around the spring. In other words, the manufacturing method is a fusible or lost core molding process with the addition of a spring which is preset in the core. The method generally includes three main steps: molding a two-part spring and core material, molding the seal by wrapping rubber, fabric, and silicone layers around the spring and core material combination, and removing the core material so that the spring is left behind within a cavity of the layered seal. The step of molding the spring and core material includes the substeps of creating a salt mold, from melted blue temp salt #430, laying the spring in the cavity in the mold, clamping the mold with the spring therein, and pouring Paraplast® into the mold to form the Paraplast® mandrel and spring core. Lastly, the mold is allowed to cool and the two-part core is removed from the mold. It is noted that the spring is not entirely covered by the core material; or in other words, the spring, or at least a portion thereof, resides on the exterior or outside of the two-part core. In this regard, the spring is retained or preset in a desired, and typically complex, shape. The step of removing the core material may include the substeps of dissolving or curing the entire seal so that the salt and/or Paraplast® core material is removed and the spring is left behind.

The invention in one form is directed to a spring that is a coil or tube spring.

The invention in another form is directed to the seal having any desired cross-section, such as an Omega or “P” cross-section.

An advantage of the present invention is a lost core molding process with the spring being preset in the core, which provides for more exact manufacture, leading to lighter weight, higher performance and ability to make complex designs

Another advantage is the seal may include multiple layers of rubber and fabric that are held together with silicone, any desired materials in the layers and any desired shape and size.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an isometric diagram of a spring-energized elastomeric seal assembly, according to an embodiment.

FIG. 2 is an isometric diagram of a biasing member of an elastomeric seal assembly, according to an embodiment.

FIG. 3 is an isometric diagram of a spring-energized elastomeric seal assembly, according to an embodiment.

FIG. 4 is a flowchart of a method for assembling either spring-energized elastomeric seal, according to an embodiment.

FIG. 5 is a flowchart of a method for assembling the spring-energized elastomeric seal assembly in FIG. 1 and the spring-energized elastomeric seal assembly in FIG. 2.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

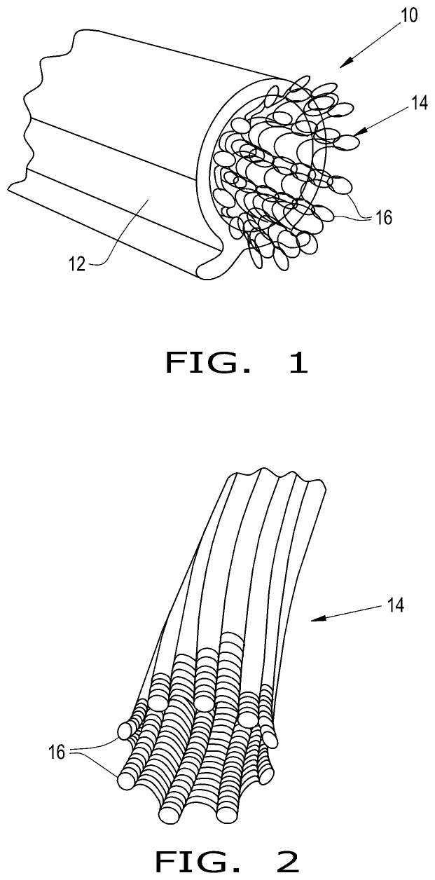

Referring now to the drawings, and more particularly to FIGS. 1-2, there is shown an embodiment of a spring-energized elastomeric seal assembly 10, such as an airframe seal assembly. The spring-energized elastomeric seal assembly 10 may generally include a hallowed seal 12 and an inner or core biasing member 14 housed within the seal 12. Due to the biasing member 14, which internally supports the seal 12, the seal 12 may maintain its desired performance characteristics, e.g. resiliency, at high operating temperatures. As used herein, high operating temperatures may refer to temperatures which are greater than 600 degrees Fahrenheit.

The spring-energized elastomeric seal assembly 10 may be used in any desired industry. For example, the spring-energized elastomeric seal assembly 10 may be used in the aerospace industry. The spring-energized elastomeric seal assembly 10 can be in the form of an airframe seal assembly which seals various components within an aircraft engine. Even under the high operating temperatures of an aircraft engine, the spring-energized elastomeric seal assembly 10, which operates as an airframe seal assembly, will maintain is desired resiliency.

The seal 12 may be considered an outer shell 12 as it defines a housing for the inner biasing member 14. The seal 12 may include multiple layers of rubber and fabric that are held together with silicone. However, the seal 12 may comprise any desired material. The seal 12 may have any desired shape and size. For instance, the seal 12 may have an “omega”-shaped cross-section. Alternatively, the seal 12 may have a substantially “P”-shaped cross-section, wherein the inner biasing member 14 is located within the closed loop of the “P”. As can be appreciated, the seal 12 may be coated with an outer protective coating, such as an elastomer-based coating, a silica-based coating, or any other desired coating.

The inner biasing member 14 may be located and housed within an internal space within the seal 12. The inner biasing member 14 may be in the form of a spring structure 14 that internally supports the whole body of the seal 12. The spring structure 14 acts as the primary resilient element for the seal 12. The spring structure 14 may be composed of multiple strands or wires 16 that are knitted together to form multiple interconnected loops (FIG. 2). Thereby, the spring structure 14 may define a meshed and resilient internal support member for counteracting the various external forces acting upon the seal 12. The strands 16 of the spring structure 14 may comprise any desired material such as a metal, ceramic, and/or suitable elastic material. The spring structure 14 may have any desired shape and size, which may or may not correspond to the shape and size of the seal 12. The spring structure 14 may be in the form of a spring tube. Additionally, the spring structure 14 may be in the form of an open-sided structure, for example a C-shaped structure. It is conceivable that the inner biasing member 14 may be in the form of a coil spring. It should also be appreciated that the spring structure 14 may or may not have a hollow center. For example, the spring structure 14 may have a non-hollow honeycomb structure. The honeycomb structure may be a non-wire type spring, such as a suitable elastic material, which is sufficiently flexible. As can be appreciated, the spring structure 14 may be optimized for altering its various performance characteristics as desired. For instance, the loop density, the number of individual loops along the circumference, the loop length, and/or the wire diameter may be altered to achieve a desired set of performance characteristics.

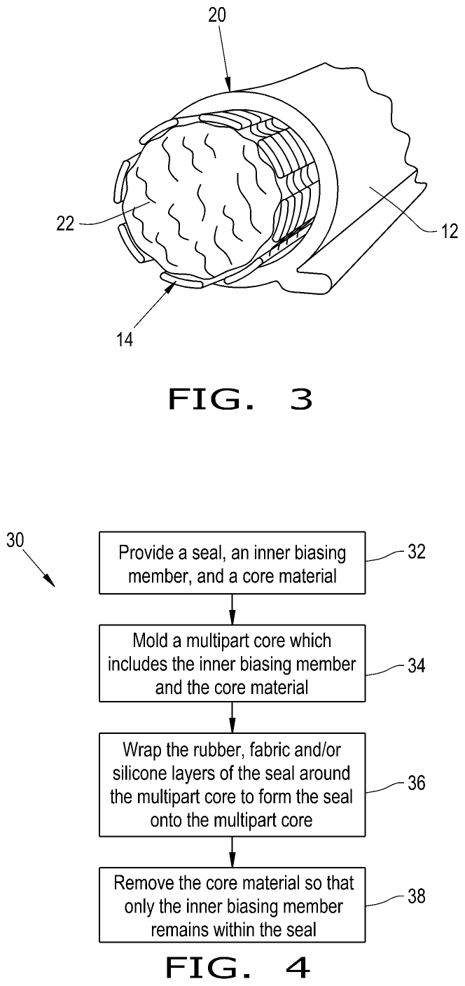

Referring now to FIG. 3, there is shown another embodiment of a spring-energized elastomeric seal assembly 20. The spring-energized elastomeric seal assembly 20 may be substantially similar to the spring-energized elastomeric seal assembly 10, as discussed above, except that the spring-energized elastomeric seal assembly 20 additionally includes an insulating material 22 that is located within the spring structure 14. Like elements between the spring-energized elastomeric seal assembly 10 and spring-energized elastomeric seal assembly 20 have been identified with like reference characters.

The insulating material 22 may be housed within the spring structure 14. The insulating material 22 may act as a thermal barrier to protect the spring structure 14 and/or the seal 12 from heat. The insulating material 22 may be composed of any desired material, such as wool, ceramic, or other materials.

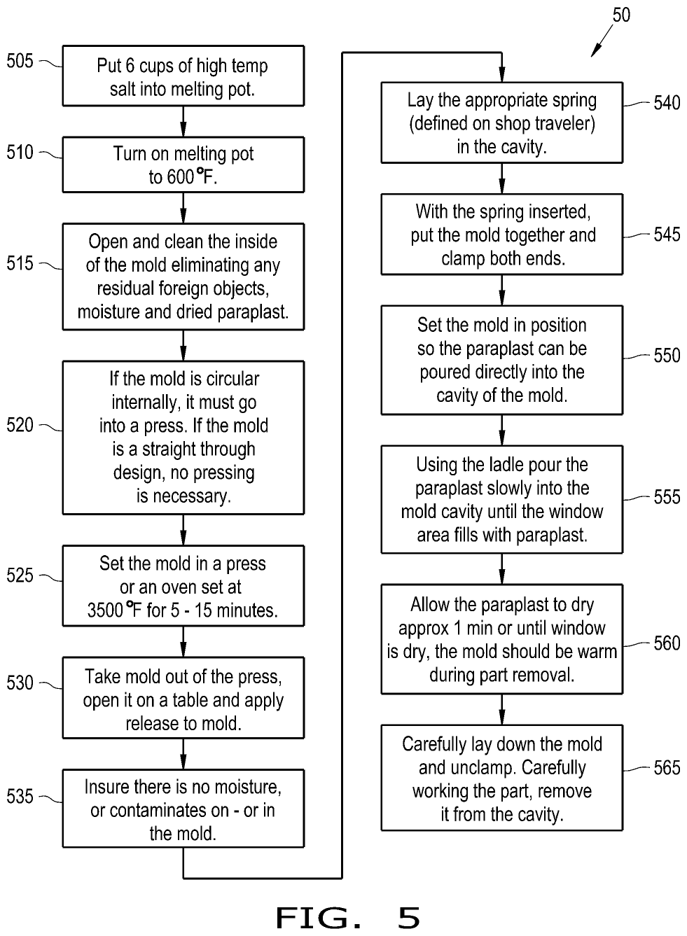

Referring now to FIG. 4, there is shown a flowchart of a method 30 for assembling the spring-energized elastomeric seal assembly 10 in FIG. 1 and the spring-energized elastomeric seal assembly 20 in FIG. 2. By way of example only, the method 30 is discussed herein with reference to the spring-energized elastomeric seal 10. The method 30 may initially include providing a seal 12, which includes multiple material layers, a spring structure 14, and a core material which forms a temporary core (at block 32). The method 30 may include molding a core, such a multipart core (at block 34). The multipart core includes the spring structure 14 and the core material that forms the temporary core. This multipart core may be considered a fusible or lost core for temporarily retaining the spring structure 14. In other words, the core material, which forms the temporary core, retains or pre-shapes the spring structure 14 in a desired shape before the exterior seal material of the seal 12 is bonded onto or around the spring structure 14.

Thus, the initial core molding procedure serves to pre-shape the spring structure 14 so that the spring structure 14 may be formed into a complex shape without regard of subsequently forming and/or fitting the spring structure 14 relative to the seal 12. The molding of the multipart core may include creating a mold, such as a salt mold with two corresponding halves, laying the spring structure 14 within a pre-shaped cavity of one of the halves of the mold, and clamping the halves of the mold together with the spring structure 14 therein.

Next, the molding of the multipart core may include adding the temporary core material to the mold to form the temporary core mold that temporarily retains the shape of the spring structure 14. It should be appreciated that temporary core material may comprise a polyisobutylene mixture, such as Paraplast®. However, the core material may comprise any desired material, such as a removable wax. Thereafter, the mold may be allowed to cool, and the two-part core can be removed from the mold. At this stage, the core material serves as a removable mandrel such that the spring structure 14 is retained in its final shape. It is noted that the spring structure 14 may not be entirely covered by the core material; or in other words, the spring structure 14, or at least a portion thereof, may reside on the exterior or outside of the core material. Paraplast® is a mixture of 98% or more of highly purified paraffin with the remaining mixture being Polyisobutylene. Polyisobutylene (C₄H₈)ₙ is a synthetic elastomer (a natural or synthetic polymer exhibiting elastic properties) with strong oxygen barrier properties. Polyisobutylene is generally colorless but may have a light yellow color and it is generally odorless and tasteless although it may have a slight odor. Polyisobutylene is the homopolymer of isobutylene

Next, the method 30 may include applying the rubber, fabric, and/or silicone layers onto the multipart core mold to form the seal 12 thereon (at block 36). The step of applying the layers onto the multipart core mold may include any desired application process, such as wrapping, tape laying, oriented fiber injection molding, etc. Thus, the seal 12 at least partially takes on the preformed shape of the spring structure 14.

Thereafter, the method 30 may include removing the preformed core material so that only the spring structure 14 is left behind within the internal space of the seal 12 (at block 38). The process of removing the temporary core material may include dissolving, mechanical shock/rupture, electrical or magnetic wave changes, and/or curing the spring-energized elastomeric seal assembly 10, which operates as an airframe seal assembly 10. Thereby, once the salt of the mold and/or Paraplast® temporary core is removed, spring structure 14 is left behind within the seal 12. If the spring-energized elastomeric seal assembly has insulation, such as the insulating material 22 of the spring-energized elastomeric seal assembly 20, then the method 30 may additionally include a step of inserting the insulating material 22 into the open cavity of the spring structure 14.

Referring now to FIG. 5, there is shown a flowchart of a method 50 for assembling the spring-energized elastomeric seal assembly 10 in FIG. 1 and the spring-energized elastomeric seal assembly in FIG. 20. By way of example only, the method 50 is discussed herein with reference to the spring-energized elastomeric seal 10. The method 50 may initially include putting 6 cups of high temp salt into melting pot 505, the turn on melting pot to 600*F 510, the open and clean the inside of the mold eliminating any residual foreign objects, moisture and dried Paraplast® 515. If the mold is circular internally, it must go into a press. If the mold is a straight through design, no pressing is necessary 520. Then set the mold in a press or an oven set at 350° F. for 5 to 15 minutes 525, and take mold out of the press, open it on a table and apply release to mold 530, ensure there is not moisture or contaminants on or in the mold 535, then lay the appropriate spring (defined on shop traveler) in the cavity 540 and with the spring inserted, put the mold together and clamp both ends 545, set the mold in position so the Paraplast® can be poured directly into the cavity of the mold 550, the using the ladle pour the Paraplast® slowly into the mold cavity until the widow area fills with Paraplast® 555, allow the Paraplast® to dry approx. 17 min or until window is dry, the mold should be warm during part removal 560 and carefully lay down the mold and unclamp. Carefully working the part, remove it from the cavity 565.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for assembling a seal assembly, comprising:
providing a seal, a biasing member in a shape of a spring structure, and a core material, the seal including a plurality of material layers;
molding a core, the core including the spring structure and the core material, the core material being configured for temporarily retaining the spring structure;
applying the plurality of material layers onto the core for forming the seal onto the core; and
removing the core material such that only the spring structure is housed within the seal.

2. The method of claim 1, wherein the removing the core material further comprises dissolving the seal so that the core material is removed and only the spring structure remains.

3. The method of claim 1, wherein the core material further comprises a wax.

4. The method of claim 1, wherein the spring structure is not entirely covered by the core material.

5. The method of claim 1, wherein a portion of the spring structure does not reside on an exterior or outside of the core material.

6. The method of claim 1, wherein molding the spring structure and the core material further comprises creating a salt mold, from melted blue temp salt #430, laying the spring structure in a cavity in the salt mold, clamping the salt mold with the spring structure therein, and pouring a polyisobutylene mixture into the salt mold to form a polyisobutylene mixture mandrel and spring structure.

7. A seal assembly, comprising:
a seal defining a housing; and
an inner biasing member housed within the seal, the inner biasing member being configured to be pre-shaped in a core such that the inner biasing member has a shape which corresponds to a shape of the seal.

8. The seal assembly of claim 7, wherein the inner biasing member further comprises a spring.

9. The seal assembly of claim 7, wherein the seal has a substantially “P”-shaped cross-section having a closed loop, wherein the inner biasing member is located within the closed loop.

10. The seal assembly of claim 7, further comprising insulating material being housed within the inner biasing member, the insulating material acting as a thermal barrier to protect the inner biasing member and the seal from heat.

11. The seal assembly of claim 7, wherein the seal is bonded onto the inner biasing member.

12. The seal assembly of claim 7, wherein the seal assembly is in a form of an airframe seal assembly which seals various components within an aircraft engine.

13. A method for assembling a seal assembly, comprising:
presetting a biasing member in a temporary core material; and
performing a lost core molding process with the biasing member being preset in the temporary core material.

14. The method of claim 13, further comprising creating a mold, such as a salt mold with two corresponding halves.

15. The method of claim 14, wherein presetting the biasing member further comprises laying the biasing member within a pre-shaped cavity of one of the two corresponding halves of the mold, and clamping the two corresponding halves of the mold together with the biasing member.

16. The method of claim 15, wherein the lost core molding process further comprises adding the temporary core material to the mold to form a temporary core mold that temporarily retains a shape of the biasing member, forming a two-part core.

17. The method of claim 16, wherein the lost core molding process further comprises after the mold has cooled, then removing the two-part core from the mold, thereupon, the temporary core material serves as a removable mandrel such that the biasing member is retained in a final shape.

18. The method of claim 17, wherein removing the two-part core from the mold further comprises removing preformed core material so that only the biasing member is left behind within the seal assembly.

19. The method of claim 13, wherein the temporary core material further comprises a polyisobutylene mixture.

20. The method of claim 13, wherein the biasing member further comprises a spring.
